(19) United States
(12) Patent Application Publication
(10) Pub. No.: US 2006/0280322 A1
(43) Pub. Date: Dec. 14, 2006

(54) Discreet interface system

(76) Inventor: kaho Abe, Brooklyn, NY (US)

Correspondence Address: JONES DAY, 222 EAST 41ST ST, NEW YORK, NY, 10017, US

(21) Appl. No.: 11/437,599

(22) Filed: May 19, 2006

Related U.S. Application Data
(60) Provisional application No. 60/682,529, filed on May 19, 2005.

(51) Int. Cl. H04R 5/02

(52) U.S. Cl. 381/300

(57) ABSTRACT

The present invention relates generally to a system for interfacing electronic devices with at least one garment. In particular, the invention pertains to a washable system for interfacing electronic devices with at least one garment wherein the system includes at least one connector, a conductive material, and at least one user interface.

This application claims the benefit of U.S. Provisional Application No. 60/682,529, filed May 19, 2005 the contents of which are incorporated herein in its entirety.

### FIELD OF THE INVENTION

The present invention relates generally to a system for interfacing electronic devices with an item of clothing. In particular, the invention relates to a washable interface system that includes a system connector, conductive material, and a user interface.

### BACKGROUND

The current trend regarding electronic devices is to make such devices smaller, more portable, and ubiquitous. This miniaturization of technology has lead some manufacturers to try and incorporate electronic devices into clothing. Such wearable technology can allow the user to access and use the technology while at the same time keeping their hands free. Also such wearable technology can ultimately eliminate the need for a bag, purse or briefcase to carry the electronic devices.

Currently, however, there is a gap between fashion as we know it and wearable technology. To date many of the examples of wearable technology suffer from certain limitations. Specifically, there are three main limitations to currently available examples of wearable technology. The first is that many currently available examples of wearable technology are not washable, making them extremely impractical for everyday wear. Secondly, currently available examples of wearable technology are cumbersome, stiff and extremely noticeable, making them not only uncomfortable but also inappropriate to wear in certain situations. Lastly, many examples of wearable technology are only designed to accommodate one type of technology. For example, some athletic jackets containing interface systems, allow the user to use and control an MP3 player using a noticeable keypad located on the sleeve of the jacket. The interface system eliminates the need for the user to physically access the MP3 player itself. Such wearable technology systems, however, only enable the jacket to interface with one type electronic device, the MP3 player and do not enable the user to “plug-in” and use other electronic devices such as mobile phones and personal data assistants.

Therefore there exists a need for wearable technology that is not only washable, but can also be completely integrated into clothing. There is also a need for wearable technology that can interface with different types of technology. Additionally there is also a need for a method of making such wearable technology.

### SUMMARY

As used herein and unless otherwise indicated the phrase “discreet interface” means an interface, such as an electronic interface or user interface, that is designed so the visible portion of the interface system includes traditional garment features such as garment trims that are customarily found on garments. By having traditional garment features comprise the visible portion of the interface system, the system is not visually obvious and is discreet, allowing the user to remain sensitive to their social and physical environment.

The present invention is directed to an interface system that can be incorporated into conventional clothing and can give the user control over various technologies, such as, but not limited to, mobile phones, MP3 players, personal data assistants (PDAs), voice recorders, and heating or cooling systems, by providing controls which are not visually obvious and incorporated into and indistinguishable from existing garment features such as buttons, snaps, clasps and other garment trims of the clothing. The purpose of this invention is to allow the user to discreetly access and control a variety of technologies through the contact and manipulation of traditional garment trims. The discreet nature of the interface system gives the user the freedom to access, use and control personal technologies without attracting attention.

One main concept of the discreet interface system of the present invention is that a garment becomes the interface for the technology. Ultimately, certain features on the garment are used to access and use the technology. Ideally, the garment allows the user to access and control the processing power and various other capabilities of the technology to run algorithms, access wireless networks, and store data without having to physically access and manipulate the electronic device itself. The modularity of the discreet interface system is another main concept, as it provides many solutions to current issues regarding wearable technology such as, washability, interchangeability, and ubiquity.

The discretion of discreet interface system allows the user to utilize the technology while remaining sensitive to the social and physical environment. There are no intimidating or awkward keyboards, screens or wires exposed. Instead the interface of the technology includes the features of the garment such as, traditional garment trims. In this way, the user can be comfortable wearing something familiar, while having the access to technology.

The modularity of the discreet interface system allows the technology to be ubiquitous. The user is able to use the same technology, even if the user decides to change garments. The user also is able to use a variety of technologies with the same garment. Additionally, the modularity of the discreet interface, permitting the removal of the personal technology, system allows the garment to be washed.

The interface systems of the present invention includes, for example, a system for interfacing electronic devices with at least one garment comprising an interface system having at least one washable system connector; conductive fabric in electrical communication with the washable system connector; and at least one user interface in electronic communication with the conductive fabric, wherein the user interface comprises at least a portion of a garment trim. In preferred embodiments, the user interface is discreet and the interface system is substantially free of wires.

The system connectors used in the interface systems of the present invention can be flexible. In certain embodiment, the system connector comprises a polymer. Polymers can be intrinsically conductive polymers or non-conductive polymers. Examples of suitable non-conductive polymers include, but are not limited to, silicone based polymers, polyurethanes, thermoplastic elastomers, ethylene vinyl acetate copolymers, polyolefin elastomers, EPDM rubbers or combinations thereof. The system connectors in the interface systems of the present invention can further comprises a conductive coating material; a fastener, such as loop-and-hook fasteners or a combination thereof.

Preferably, the system connector can be removably attached to an adaptor. The adaptor can include integrated circuitry and a device connector, wherein the device connector can be removably attached to the system connector. The adaptor can also be removably attached to an electronic device.

The conductive fabric used in the interface systems of the present invention can include a metallic material. Suitable metallic materials include, but are not limited to, metals such as copper, silver, zinc, nickel, brass, gold, aluminum, stainless steel or a combination thereof. For example the conductive fabric can be metallic organza, metallic mesh and metal plated nylon, such as copper plated nylon.

Suitable examples of garment trims used in the systems of the present invention, include but are not limited to, snaps, buttons, clasps, zippers, studs, ribbons, rivets, spikes, grommets, or a combination thereof.

The interface systems of the present invention can further include at least one switch, wherein the switch is incorporated within the garment.

The present invention is also directed to a washable garment comprising an interface system comprising at least one garment trim; conductive fabric, conductive thread, or conductive polymer in electronic communication with the garment trim, wherein the conductive fabric, conductive thread or conductive polymer is capable of being integrated in the garment; and a washable system connector in electronic communication with the conductive fabric, conductive thread or conductive polymer, wherein the washable system connector comprises a polymer.

In preferred embodiments, the washable garment includes an interface system that is discreet. The interface system incorporated in the washable garment can also include at least one switch, wherein the switch is incorporated into the garment.

Suitable examples of garment trims used in the systems of the present invention, include but are not limited to, snaps, buttons, clasps, zippers, studs, ribbons, rivets, spikes, grommets, or a combination thereof.

The conductive fabric or conductive thread incorporated in the washable garment can include a metallic material. Suitable metallic fabrics include, but are not limited to, metals such as copper, silver, zinc, nickel, brass, gold, aluminum, stainless steel, or a combination thereof. An example of conductive fabric can include metallic organza, metallic mesh and metal plated nylon, such as copper plated nylon.

The system connectors incorporated in the washable garment can be flexible. In certain embodiment, the system connector comprises a polymer. Suitable polymers include intrinsically conductive polymers and non-conductive polymers. Examples of suitable non-conductive polymers include, but are not limited to, silicone based polymers, polyurethanes, thermoplastic elastomers, ethylene vinyl acetate copolymers, polyolefin elastomers, EPDM rubbers or a combinations thereof.

The system connectors in the interface systems of the present invention can further comprises a conductive coating; a fastener, such as loop-and-hook fasteners or a combination thereof.

Also, in certain embodiments the garment is substantially free of wires. Suitable garments include, but are not limited to, jackets.

### SUMMARY OF THE DRAWINGS

FIG. 1 shows an external view of a garment comprising the discreet interface system of the present invention.

FIG. 2 shows a “see-through” view of a garment comprising the discreet interface system of the present invention.

FIG. 3 shows an example of a personal electronic device connected to a discreet interface system of the present invention.

FIG. 4 shows an example of a personal electronic device connected to a discreet interface system of the present invention, with the personal electronic device partially disposed in a pocket.

FIG. 5 shows an example of personal electronic device connected to a discreet interface system of the present invention, with the personal electronic device completely disposed in a pocket.

FIG. 6 shows an example of a personal electronic device connected to a discreet interface system of the present invention, with a personal electronic device in pocket, and the pocket is closed.

FIG. 7 shows an example of an adaptor and a personal electronic device that can be used in connection with the discreet interface systems of the present invention.

FIG. 8 shows an example of a system and device connector that can be used in the discreet interface system of the present invention.

FIG. 9 shows an example of a system connector that can be used in the discreet interface system of the present invention.

FIG. 10 show an example of garment trims in electrical communication with conductive fabric.

FIG. 11 show another example of garment trims in electrical communication with conductive fabric.

FIG. 12 show another example of garment trims in electrical communication with conductive fabric.

FIG. 13 shows one example of squeeze tab switches that can be used in connection with the interface system of the present invention.

### DETAILED DESCRIPTION OF THE DRAWINGS

The present invention is directed towards a system for interfacing electronic devices with at least one garment. The purpose of the system is to provide a way for the wearer of the garment to use, access, and control an electronic device. Additionally, the system is discreet allowing the user to remain sensitive to their social and environmental environment. The discreet nature of the interface system arises from the use of features and materials traditionally found on garments, as controls for the electronic device, as well as, the additional interface system components that are flexible and washable and maintain the feel of a traditional garment.

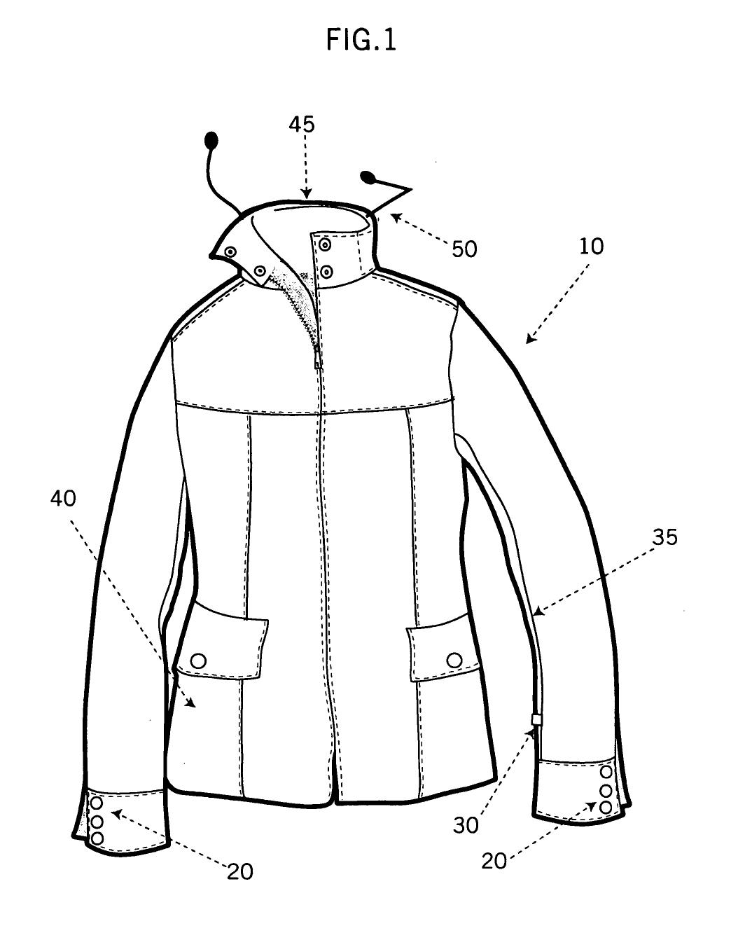

FIG. 1 shows an external view of a garment comprising one embodiment of the discreet interface system of the present invention. The garment 10 comprises conductive snaps 20 that can act as capacitive switches to control a personal electronic device, such as an MP3 player. Garment 10 also includes a squeeze tab switch 30, sewn into seam 35, located on the sleeve of the garment. Switch 30 can be used to allow the user to lock or essentially disable the discreet interface system when the user does not wish to use an electronic device, or unlock or essentially enable the discreet interface system when the user wishes to use an electronic device. Also, once the user is using the electronic device, the squeeze tab switch can lock the settings and prevent any inadvertent contact with the garment trims that could adjust the settings. Pocket 40 on garment 10 can be used to house the electronic device. The garment 10 can optionally include ear phones 50 that can be folded away inside collar 45 when they are not in use.

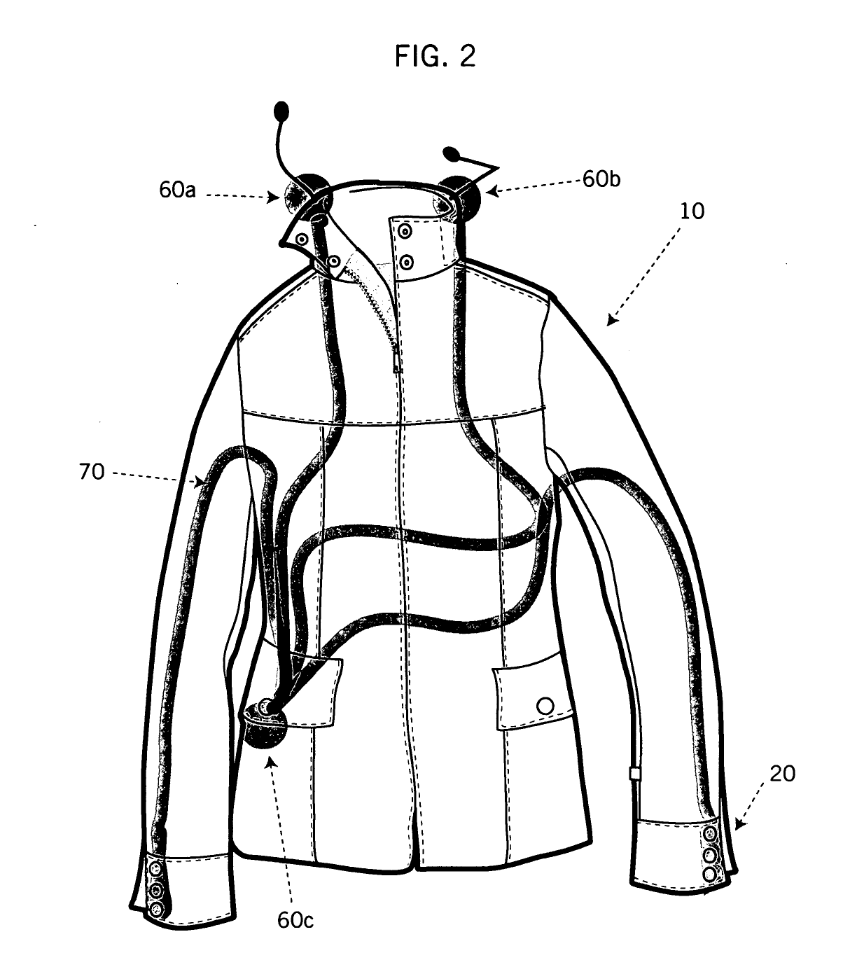

FIG. 2 shows a garment comprising an embodiment of the discreet interface system of the present invention. Garment 10 includes a discreet interface system of the present invention that has snaps 20, at least one system connector, and conductive material 70. As shown in FIG. 2 the discreet interface system integrated into garment 10 has three system connectors 60a, 60b, and 60c. The system connectors 60a, 60b, and 60c are sewn onto or otherwise attached to the conductive material 70 and can be used to connect an electronic device to the discreet interface system. System connector 60c located in pocket 40 can be used to connect to a personal electronic device, such as an MP3 player, to the discreet interface system. The system connectors 60a and 60b can be used to attach ear phones to the discreet interface system.

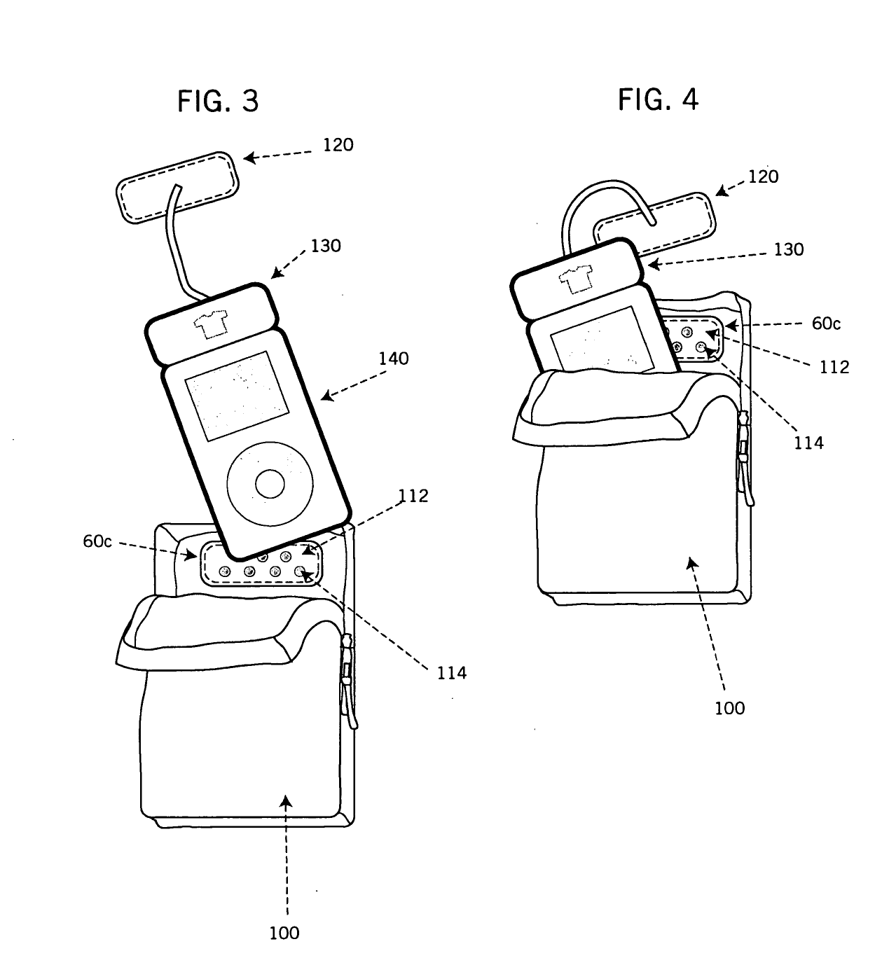

FIGS. 3-6 show an example of how an electronic device can be connected to a discreet interface system of the present invention. An electronic device is connected to the discreet interface system via a system connector. FIG. 3 shows a system connector 60c which can be used to connect the personal electronic device 140 to the discreet interface system. System connector 60c is housed in pocket 100. Pocket 100 can be attached to a garment. For example pocket 100 can be sewn in to a garment and can be made out of the same fabric as the garment. System connector 60c, housed in pocket 100 comprises loop-and-hook fasteners 112 and a polymer 114.

Personal electronic device 140 is connected to an adaptor which can include interface circuitry 130 and a device connector 120. Device connector 120 can also comprise loop-and-hook fasteners and a polymer. The personal electronic device 140 is connected to the discreet interface system by connecting system connector 60c to device connector 120.

In FIG. 4 personal electronic device 140 is partially disposed in pocket 100 that houses system connector 60c. As shown in FIG. 4, personal electronic device 140 is connected to an adaptor which includes interface circuitry 130 and a device connector 120. The personal electronic device 140 is connected to the discreet interface system by connecting device connector 120 to system connector 60c.

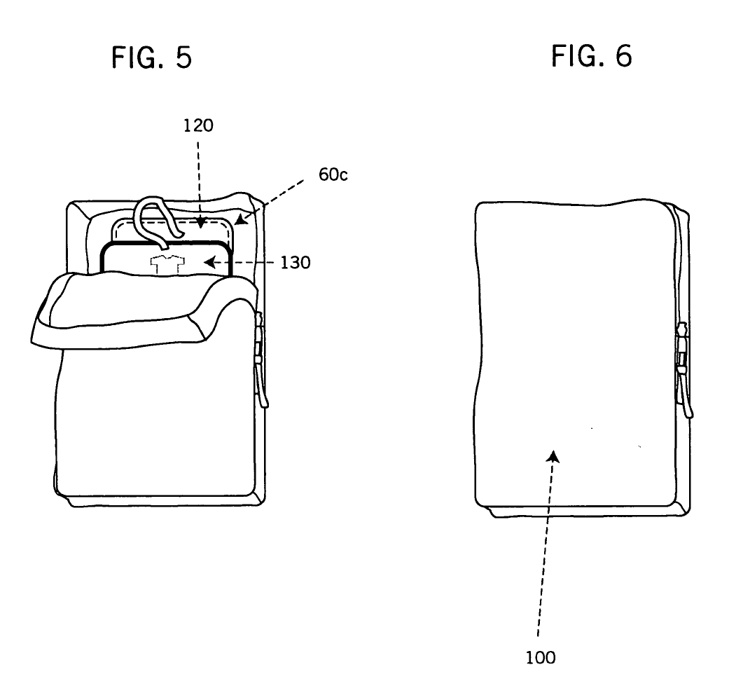

In FIG. 5 personal electronic device is completely disposed in pocket 100. As shown in FIG. 5, the personal electronic device is connected to the discreet interface system by connecting device connector 120 to system connector 60c.

FIG. 6 shows sealed pocket 100.

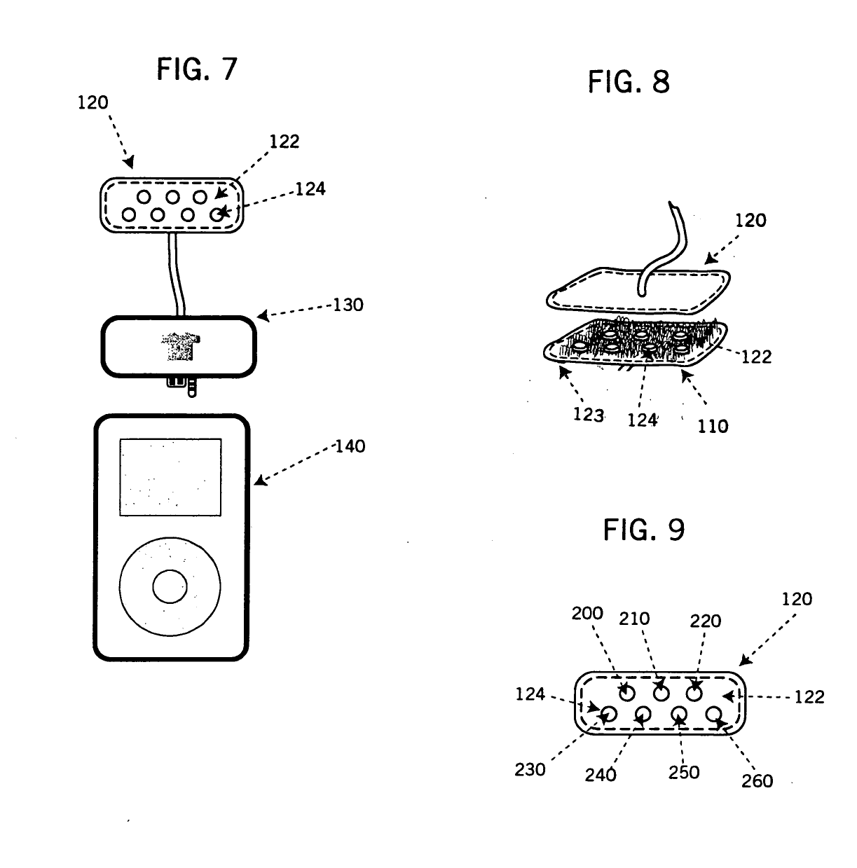

FIG. 7 shows a close-up view of personal electronic device 140 which, as shown in FIG. 7 is an MP3 player and adaptor comprising device connector 120 and interface circuitry 130. Device connector 120 comprises hook-and-loop fasteners 122, such as Velcro, and a polymer. The polymer is shaped as a polymer layer having a plurality of polymer nubs 124. The hook-and-loop fasteners 122 are attached to the polymer layer, allowing the nubs 124 to be exposed. Device connector 120 is connected to an interface circuitry 130 which is connected to a personal electronic device 140. Interface circuitry 130 processes commands from the user interface e.g. the garment trims, to control the electrical device connected to the interface system. Each type of electronic device, e.g., an MP3 player, a mobile phone, or a personal computing device, can have a separate and individualized interface circuitry. Examples of suitable interface circuitry include, but are not limited to, circuit boards with one or more integrated circuits capable of processing the commands from the user interface. The interface circuitry, as well as the electronic devices, will be able to be switched out to allow the user to use various types of electronic devices with the discreet interface system. The ability to remove the interface circuitry and the personal electronic devices from the discreet interface system allows the garment and the discreet interface to be laundered.

FIG. 8 is a close-up view of a system connector 110 and a device connector 120. The system connector 110 and the device connector 120 can comprise hook-and-loop fasteners 122 and a polymer. The polymer in this embodiment is shaped as a polymer layer 123 having a plurality of nubs 124. In certain embodiments the polymer used in the connectors is conductive, such as intrinsically conductive polymers. However, non-conductive polymers can be used. In such embodiments, a portion of the polymer can be coated with a conductive coating. For example, a portion of the polymer can be coated or covered with conductive tape or conductive fabric. The conductive fabric can cover the side of the system connector that is opposite the side containing the nubs and be looped through the system connector to cover the polymer nubs. The system connector 110 and device connector 120 are connected to each other by matching up the polymer nubs 124 on the system connector 110 and device connector 120. The connectors are then held together by the hook-and-loop fasteners 122.

FIG. 9 shows another close-up view of a system connector 120 comprising hook-and-loop fasteners 122 and a polymer where, in this embodiment the polymer is shaped as a polymer layer having a plurality of nubs 200-260. The nubs 200-260 can be coated with a conductive coating and form an electrical connection transmitting signals for using or controlling an electronic device, such as an MP3 player. The nubs 200-260 can each serve a specific function. For example, nub 200 can be audio left, nub 210 can be audio right, nub 220 can be audio ground and nubs 230 to 260 can transmit commands to enable the user to select desired songs, such as Stop, Play, Pause, Volume Up and Volume Down. Each nub can correspond to one or multiple commands. Multiple electrical signals are kept isolated by using distinct circuit paths comprised of strips of conductive material. The number of nubs and the arrangement of the nubs can be changed depending on the location of the system connector on the garment and the function of the technology it is connected to.

Connectors

As discussed above, the present invention is directed to a system for interfacing electronic devices with at least one garment comprising an interface system. The interface system of the present invention can include at least one system connector that is capable of being removably attached to an electronic device.

In certain embodiments, the system connectors are washable, meaning they can be laundered multiple times without losing their ability to connect and maintain an electrical connection between the interface system of the present invention and an electronic device.

Additionally, the connectors are flexible, so that when they are incorporated into the garment they do not make the garment uncomfortable. Also, the system connectors can be lightweight so that they do not add much additional weight to the garment itself.

The system connectors of the present invention can be removably attached to a variety of different types of electronic devices. In certain embodiments, the system connectors are connected to an electronic device via an adaptor. Suitable adaptors can comprise of a device connector and interface circuitry. In other embodiments, the system connector is connected to an electronic device via a device connector which is directly connected to an electronic device, without the need for interface circuitry. The system connectors can be removably attached to the adaptors or the device connectors, this enables multiple types of electronic devices to be interchanged and used with the interface systems of the present invention. Also the ability to remove and change electronic devices allows the electronic devices to be removed prior to washing the garment in which the interface system is incorporated.

Additionally, adaptors and device connectors can be removably attached to electronic devices. This interchangeability allows an adaptor or a device connector to be used with more than one electronic device, as well as, allows more than one adaptor or device connector to be used with a single electronic device.

In certain embodiments system connectors and device connectors can be made out of similar materials. System and device connectors can be made of any material. Preferably system connectors are made out of any material, so long as, the system connectors are washable and are capable of connecting and maintaining an electrical connection between the electronic device via an adaptor or device connector. In certain embodiments system and device connectors comprise a polymer.

Suitable polymers for use in the connectors are preferably flexible, washable, lightweight, and long lasting. Such polymers can be conductive or non-conductive polymers.

In certain embodiments, systems connectors comprise conductive polymers, such as, but not limited to, intrinsically conductive polymers (ICPs). ICPs are polymers that conduct electric currents without the addition of conductive (inorganic) substances. Suitable examples of ICPs include, but are not limited to polyanilines.

Suitable examples of non-conductive polymers include, but are not limited to, elastomeric polymers such as silicones (e.g. polysiloxanes and substituted polysiloxanes), polyurethanes, thermoplastic elastomers, ethylene vinyl acetate copolymers, polyolefin elastomers, and EPDM rubbers.

Other suitable polymers include, but are not limited to, acid polymers such as polymers containing methacrylic acid and/or acrylic acid, styrene-isobutylene-copolymers, polyurethane and its copolymers, ethylene-alphaolefin copolymers, acrylic polymers and copolymers, polymethacrylates, polyacrylimides, vinyl halide polymers, polyvinylidene halides, polyvinyl ethers, polyvinylidene halides, polyvinyl ketones, polyvinyl aromatics, copolymers of vinyl monomers, copolymers of vinyl monomers and olefins such as ethylene-methyl methacrylate copolymers, polyamides, alkyd resins, polycarbonates, polyoxymethylenes, ethylene-vinyl acetate copolymers, polyamides, polyimides, polyethers, epoxy resins, alkyd resins, cellulosics, polyamides, polyesters, polysulfones, polytetrafluorethylenes, fluorosilicones, polycarbonates, acrylonitrile-styrene copolymers, ABS (acrylonitrile-butadiene-styrene) resins, acrylonitrile butadiene styrene copolymers, acrylics, polylactic acid, polylactic acid-polyethylene oxide copolymers, polycarbonates, polysaccharides, phospholipids, gelatins, cellulose ethers, collagens, chitosans, and chitins, or a combination of the foregoing. Preferably, polymeric materials include acid polymers such as methacrylic and/or acrylic acid polymers, gelatins, carboxy-methyl celluloses, hyaluronic acid polymers and pectin.

Still other examples of suitable polymeric materials include, without limitation, styrene-isobutylene-styrene, polystyrene, polyacrylonitrile, rayon-triacetate, Nylon 66, ethylene vinyl-acetate, polyethylene terephtalate, polyvinyl acetate, polyvinyl chloride, polyvinyl methyl ether, polyvinylidene fluoride, polyvinylidene chloride, polyglycolic acid, polycaprolactone, cellulose, cellulose acetate, cellulose butyrate, cellulose acetate butyrate, cellophane, cellulose nitrate, cellulose propionate, carboxymethyl cellulose, polylactic acid, polyglycolic acid, polyethylene glycol or a combination of the foregoing.

Additionally, connectors can include a fastening system. The purpose of the fastening system is to allow system connectors to be connected to the device connectors. Suitable fastening systems include, but are not limited to, hook-and-loop fastening systems, such as, Velcro; magnets; snaps; or a combination thereof. Snaps can be made from plastic or metal.

Connectors that include non-conductive polymers can also comprise a conductive coating, wherein the conductive coating coats or covers a portion of the polymer. The conductive coating allows the system connector to form an electrical connection with electrical device via an adaptor or device connector, as well as, the conductive material incorporated in the garment. In certain embodiments, the conductive coating can be conductive tape; conductive adhesive, such as a conductive epoxy; conductive film; conductive fabric; or a combination thereof. Preferably, the conductive coating coats or covers the portion of the polymer that is in contact with the conductive material and the adaptor or device connector.

The connectors used in the interface system of the present invention can be any size or shape. For example, system connectors can be custom shaped to fit any garment. In certain embodiments the system connectors and the device connectors are the same size and shape. As shown in FIG. 8 the system and device connectors can be oval in shape. Also contemplated by the present invention are any other geometrically shaped connectors, such as, but not limited to circular, square, rectangle or triangle.

Additionally the connectors can be any size, so long as the system connector fits discreetly on or within the garment. In certain embodiments, the connectors are about 1/32 inches to 8 inches in width and/or length, preferably the connectors are about 1/16 inches to 5 inches in width and/or length. However, connectors can be of a size that is outside of the preferred ranges. Connectors can be any thickness, so long as thet can fit discreetly within or on a garment. In certain embodiments, the connectors have a thickness of less than 1 inch. In preferred embodiments the connectors have a thickness of less than 0.5 inches.

In certain embodiments system connectors included in the interface system of the present invention comprise a conductive polymer layer having a plurality of molded nubs, and hook-and-loop fasteners.

In other embodiments system connectors included in the interface system of the present invention comprise a non-conductive polymer layer having a plurality of molded nubs, hook-and-loop fasteners, and a conductive coating. In preferred embodiments, the system connectors are made from a layer of flexible molded silicone polymer having molded nubs, wherein conductive fabric or conductive tape is attached to the portion of the silicone polymer layer that contacts the conductive material integrated into the garment. In certain embodiments the silicone polymer layer that contacts the conductive material integrated into the garment is the side of the polymer layer that is opposite the side containing the polymer nubs. The conductive fabric or conductive adhesive is looped through the silicone polymer layer and covers the silicon polymer nubs that contact the device connector. A portion of a hoop-and-loop fastener system is attached to the portion of the silicon layer that contacts the device connector, allowing the coated silicone polymer nubs to be exposed. Once the system connector is connected to a device connector the exposed coated silicone nubs form an electrical connection with the electric device.

Device connectors can be made of the same materials as system connectors. For example, when both device and system connectors comprise a polymer layer having a plurality of nubs, hook-and-loop fasteners and a conductive coating, the nubs in the device connector can be pressed against their corresponding nubs on the system connector, creating a connection. The hook-and-loop fasteners hold the system and device connectors together. However, the device connector does not have to be made out of the same materials as the system connector. Moreover, the device connector does not have to be washable, since it can be removed from the garment prior to laundering. It is preferable that the device connector be light in weight and flexible so as not make the garment heavy or uncomfortable for the user.

Additionally, the connection between the system connector and the device connector does not have to be formed by nubs. Any connection known to one skilled in the art can be used, such as a plug-and-socket configuration.

Conductive Material

The discreet interface system of the present invention further comprises a conductive material such as conductive fabric, conductive thread, conductive polymer, electrical cables or wires, or a combination thereof in electrical communication with the connector.

In certain embodiments, the conductive material that is in electrical communication with at least one of the connectors is conductive fabric. Any type of conductive fabric can be used. For example, suitable conductive fabrics, include but are not limited to, fabrics having metal plated yarn that has been woven together. Some other forms of conductive fabrics that can be used are micro-metal wires interwoven into fabric or micro-metal wires that are woven into non-conductive fabric to create a conductive fabric. Also, textiles that are printed with conductive pigments as well as electronic textiles that are based on highly conductive polymers like ICPs can be used.

Suitable conductive fabrics include, but are not limited to, metallic fabrics, such as metallic organzas, metallic nylons, metallic silks, metallic meshes, or metallic velvets. Other suitable metallic fabrics include, but are not limited to, fabrics having a metallic material in them. Suitable metallic materials include, but are not limited to, copper, silver, gold, aluminum, titanium, scandium, stainless steel, tantalum, nickel, brass, chrome, cobalt, chromium, manganese, iron, platinum, iridium, niobium, vanadium, zirconium, tungsten, rhodium, ruthenium, zinc, yttrium, molybdenum, technetium, palladium, cadmium, hafnium, rhenium and combinations thereof. In certain embodiments, metal plated nylon, such as copper plated nylon is used as conductive material.

In other embodiments the conductive material can be conductive thread that is used to make or embellish the garment. Suitable conductive threads include but are not limited to metallic threads. Suitable metallic can be made from or include any type of metal of metal alloy such as, but not limited to copper, silver, gold, aluminum, titanium, scandium, stainless steel, tantalum, nickel, brass, chrome, cobalt, chromium, manganese, iron, platinum, iridium, niobium, vanadium, zirconium, tungsten, rhodium, ruthenium, zinc, yttrium, molybdenum, technetium, palladium, cadmium, hafnium, rhenium and combinations thereof. Examples of suitable metallic threads include stainless steel thread and copper thread.

The conductive fabric can be sewn or otherwise attached between the self-layer of the garment and its lining. If the garment does not have a liner the conductive fabric can be attached to the self-layer of the garment itself, and possibly be used as the garment liner. Optionally, the conductive fabric can be encased in a water-proof or water resistant, insulating layer. Such a layer can be made from non-conductive fabric such as water resistant nylon e.g. nylon coated with a polymer such as polyvinyl chloride and/or polyurethane. Alternatively, the conductive fabric can be encased in a shielding fabric to help lessen interference.

Conductive thread can be used throughout the garment. For example, conductive thread can be used to embroider designs or to simply hold pieces of the garment together or to hem the garment.

In still other embodiments, conductive polymers can also be used as a conductive material. Conductive polymers, such as ICPs can be sewn or otherwise attached to the garment to form an electrical connection between the garment trims and the system connector.

Although one advantage of using conductive fabrics, conductive thread and conductive polymers is that the interface system of the present invention is substantially free of uncomfortable, bulky wires, it is contemplated by the present invention that wires and/or cables can be used as conductive materials in the interface system of the present invention. For example, the conductive material can comprise of at least one cable or wire. Preferred cables include, but are not limited to, flat, flexible cable such as ribbon cable. Preferred wires include but are not limited to, flexible, insulated wires that can be laundered.

As used herein and unless otherwise defined “substantially free” means an interface system that contains no wires unless the wire is also used as a feature on a garment, such as a garment trim like piping or pull-cords.

User Interfaces

The interface system of the present invention also includes at least one user interface. The user interface allows the user to access, use, and control an electronic device that is connected to the discreet interface system. The interface uses traditional garment features, such as garment trims which allow the interface system to be discreet by allowing the user interface to be the visually familiar features found on garments. Conductive surfaces such as snaps, zippers, grommets and studs can be used as capacitive switches to control an electronic device. Also, mechanical switches, such as squeeze tabs or push buttons, can be used to allow the user to use, access and control the electronic device. Examples of suitable interfaces include, but are not limited to, buttons, zippers, snaps, grommets, clasps, spikes, rivets or a combination thereof.

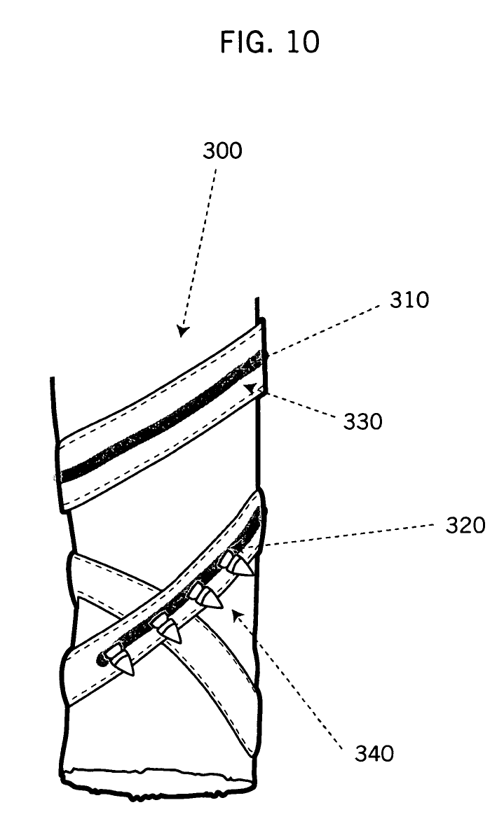

An example of a suitable user interface that can be used with the interface system of the present invention is shown in FIG. 10. FIG. 10 shows a garment sleeve 300 having conductive fabric 310 in electrical communication with spikes 320. The conductive fabric is insulated and embedded between ornamental taping 330 and the self-layer of the garment 340. The conductive fabric 310 is sandwiched between the spike 320 and the screw attaching the spike to the self-layer of the garment 340. This method of connecting insulated conductive fabric to a traditional metal garment trim by sandwiching it between the lower and upper pieces of the metal trim can be used for metal grommets, rivets and studs.

Garment buttons can act as switches by mechanical, as well as, conductive means while retaining their original function. Mechanically, garment buttons can be attached to actual push-button components or be sewn in such a way so that they can create a circuit when physically pushed down. In this case the garments buttons become like push-buttons but through a secondary mechanical relationship. Other methods include using conductive metal buttons as capacitive switches, or having the human hand create a circuit between two conductive metal buttons to trigger a switch.

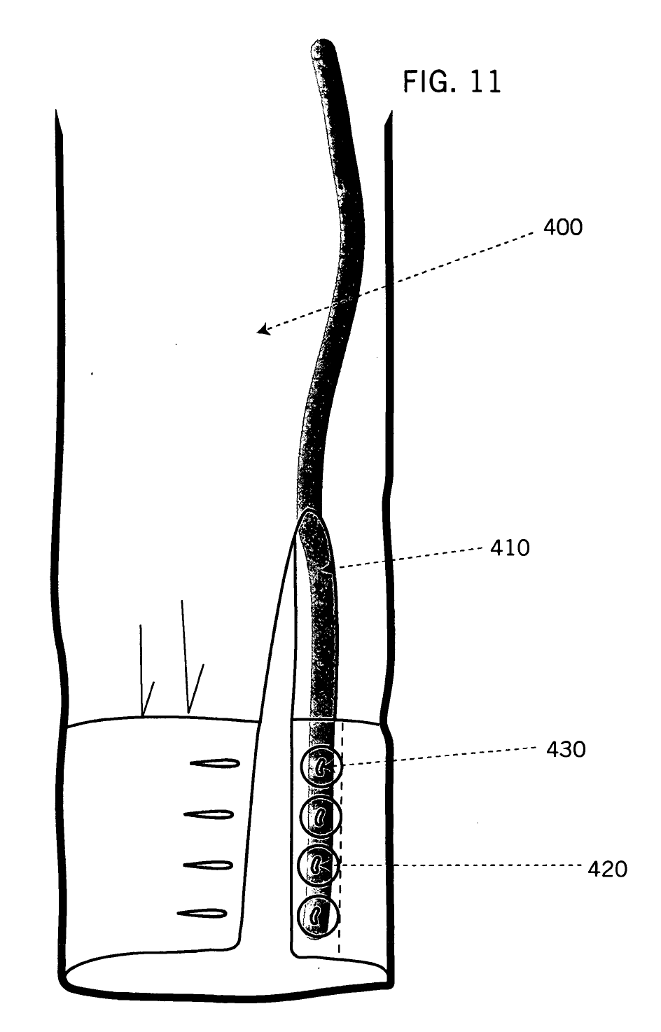

An example of buttons that can be used as a user interface with the interface system of the present invention is shown in FIG. 11. FIG. 11 shows a garment sleeve 400 with conductive fabric 410 and conductive thread 420 in electrical communication with buttons 430. The conductive thread 420 is used to attach traditional garment buttons 430. Also the conductive thread 420 on the buttons 430 is sewn through insulated conductive fabric 410.

Circuits can be created through the horizontal pairing of zipper teeth. Pieces of non-conductive film can be used to create a barrier between neighboring teeth, so that the signal is more stable. Non-conductive materials can be used to make portions of the zipper to also create a barrier between neighboring teeth. Given the layout of a zipper and the number of consecutive circuit switches that can be made the zipper is ideal for slider-type applications normally used with varying levels, such as a volume control. Zippers can also be used as a surface for capacitive switches.

Using the center front zipper as a volume slider alone may compromise the user's comfort too much, especially on a cold day. However, if there were also a heating mechanism installed into the jacket, it would be appropriate to have the heat turn up as the zipper is zipped up. Another placement for a zipper slider would be located on the sleeve, where there is less emphasis on its original functional properties.

Snaps can be used by touch as capacitive switches, as with the conductive buttons, or to create a circuit. They can also be used to establish a mode for a period of time. For example, if the user would like to lock the interface, so that none of the functions are accidentally triggered, the user could snap down a certain snap. The next time the user uses the interface she can unsnap the snap, thereby unlocking the interface. This can be thought of as being similar to a key pad lock found on a mobile phone.

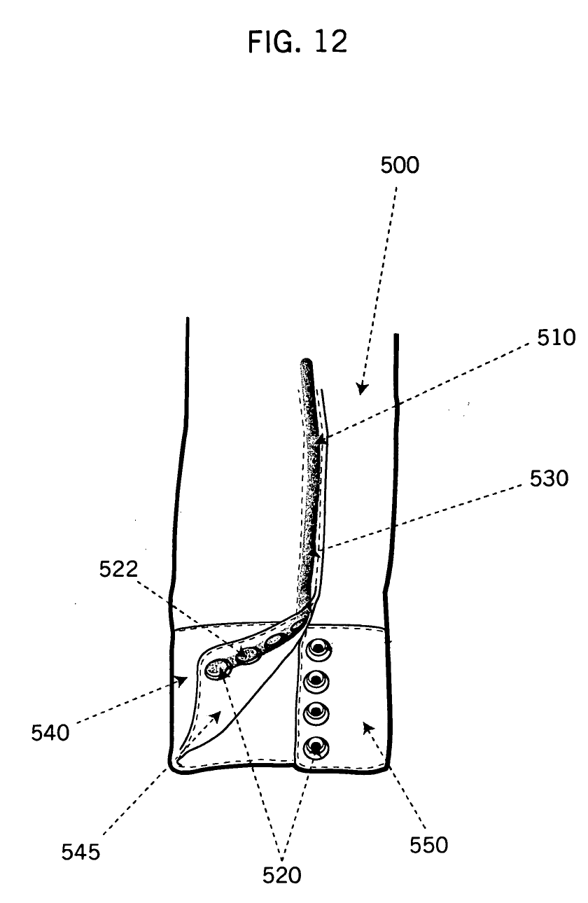

An example of snaps that can be used as a user interface with the interface system of the present invention is shown in FIG. 12. FIG. 12 shows a garment sleeve 500 with conductive fabric 510 in electrical communication with snaps 520. The conductive fabric 510 is insulated and embedded inside a seam 530, in this embodiment the seam is a welt seam. The insulated fabric 510 is connected to snaps 520 by being sandwiched between the outer 540 and inner 545 layers of the cuff fabric 550 and between the cap (not shown) and stud 522 of the metal snap 520.

Squeeze tabs can be integrated into the garment. Since the squeezing of the tab is a movement that would be difficult to recreate by accident, but also a movement that uses the force of two fingers coming together in an efficient manner, it can be used to activate or deactivate the entire discreet interface system. Alternatively, this switch, similar to the snap switch, is also an appropriate lock switch for other switches on the interface. Squeeze tabs can be a miniature, water-proof mechanical switch that is encased in a label, tag, tab, patch or other trims traditionally found on garments. Such labels, tags, tabs, or patches can be made from materials that include, but not limited to, silicone; polyvinyl chloride; rubber; leather; thermoplastic polyurethane; nylon; leather; woven natural fibers, such as, cotton and wool; or woven synthetic fibers.

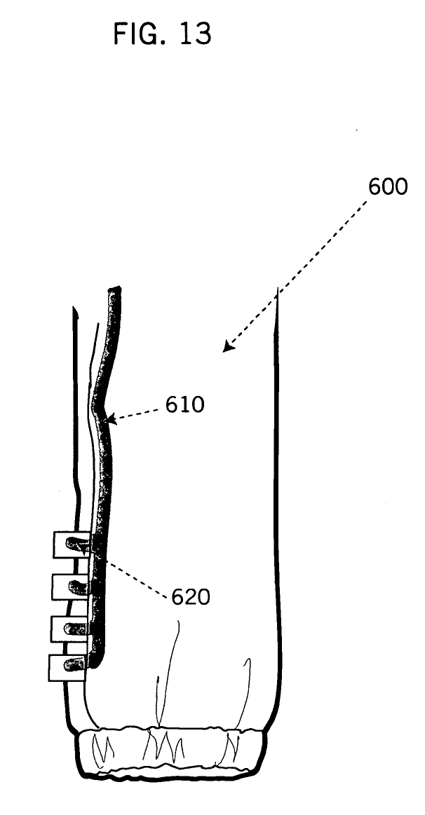

An example of squeeze tab switches that can be used as a user interface with the interface system of the present invention is shown in FIG. 13. FIG. 13 shows a garment sleeve 600 with conductive fabric 610 in electrical communication with multiple squeeze tabs 620. The conductive fabric 610 can be sewn with conductive thread or bonded with conductive bonding agent, such as conductive epoxy, to the preferably washable mechanical squeeze tabs 620 embedded inside labels or tags that are sewn into the sleeve seam.

Garment trims can be used to allow the user to use, access, or control any number of functions. For example, if the electronic device connected to the interface system of the present invention is an MP3 player, the garment trims can be used to control power, volume, song selection and any other functions that the MP3 player can perform. If the electronic device is a mobile phone, the garment trims can be used to control power, answer, end call, volume, and dialing. The functions of the garment trims of the interface system of the present invention would depend on the function of the interface circuitry.

Garments

The interface system of the present invention can be integrated into any type of garment. Suitable garments include, but are not limited to, jackets, shirts, pants, shorts, skirts, dresses, coats and jumpsuits. Additionally, the interface system of the present invention can also be integrated into accessories such as, but not limited to, bags, hats, scarves and gloves. In certain embodiments, the interface system of the present invention is integrated into jackets. Suitable jackets include suit jackets, sports jackets or casual jackets. In such jackets, conductive fabric is sewn between the self-layer of the jacket and the liner. Alternatively, conductive fabric can be sewn or otherwise attached to a separate fabric layer and sandwiched between the self-layer and the lining of the jacket.

The conductive fabric can be in electrical communication with at least one trim on the jacket. Such trims include conductive buttons, zippers, clasps, snaps, studs, spikes, rivets, patches or grommets.

Connectors can be placed in various locations on the jackets. For example, connectors can be placed within pockets, on the collar, or on the inside liner of the jacket. If connectors are not located in areas that can support a personal electronic device such as on the liner of the jacket, an additional pocket can be formed and attached to the jacket. An example of such a pocket is shown in FIGS. 3-6.

Electronic Devices

The type of technology that can be connected to the discreet interface system of the present invention can vary. In general, any type of electrical device can be attached to the interface system of the present invention. For example, personal technology or personal electronic devices can be connected to the interface system of the present invention. Personal technology includes, but in not limited to, the most widely used portable technology such as MP3 players, mobile phones, Blackberry devices or PDAs, and voice recorders.

Besides being connected to various personal technologies, the discreet interface system of the present invention can also be connected to remote control systems. The interface system can be used to control various devices such as computers, media players, laptops, CD players, DVD players, cameras and other portable or stationary devices which are capable of being controlled remotely. The interface circuitry would be able to connect with the devices with wires or that are wireless, such as, Infrared, IRDA, Bluetooth, radio frequency, Wi-Fi and other wireless methods.

Electronic devices that can also be used in connection with the interface system of the present invention include, but are not limited to, heating and cooling systems.

Other electronic devices include electronic device accessories such as, but not limited to, ear phones and microphones. Such devices can be attached to the interface system of the present invention.

Interface circuitry may be used to connect the technology and the interface system. The interface circuitry can be removably attached to the electronic devices. Additionally, the interface circuitry can be also connected to a device connector. In certain embodiments, the device connector is capable of connecting to a system connector. The interface systems of the present invention can have a plurality of system connectors, which connect to a plurality of adaptors and plurality of electronic devices. Thus the interface system of the present invention can be connected to multiple personal electronic devices simultaneously.

Methods of Making

Also encompassed by the present invention are methods of making the interface system of the present invention. In certain embodiments the methods of making include a method of making an electronic interface system that can be integrated into a garment comprising (a) providing a garment comprising at least one garment trim; (b) attaching a conductive material, such as a conductive fabric, within the garment such that the conductive material is in electrical communication with at least one garment trim; and (c) attaching at least one system connector to the conductive material such that the connector is in electrical communication with the conductive material.

The conductive material can be attached to the garment by being sewn into or otherwise attached to the garment, preferably between the self-layer of the fabric and a liner. However, in certain embodiments, the conductive material can be used as a liner or a portion of the self-layer of the garment.

Any number of system connectors can be attached to the garment. For example, a first system connector can be located within an already existing pocket or on the interior lining of the garment, and second and third system connectors can be located on or near the neck of the garment, preferably on a collar. The system connectors can be used to attach at least one electronic device to the interface system.

The description contained herein is for purposes of illustration and not for purposes of limitation. Changes and modifications may be made to the embodiments of the description and still be within the scope of the invention. Furthermore, obvious changes, modifications or variations will occur to those skilled in the art.

What is claimed:

1. A system for interfacing electronic devices with at least one garment comprising:
(a) an interface system comprising:
(i) at least one washable system connector;
(ii) conductive fabric in electrical communication with the washable system connector; and
(iii) at least one user interface in electrical communication with the conductive fabric, wherein the user interface comprises at least a portion of a garment trim.

2. The system of claim 1, wherein the user interface is discreet.

3. The system of claim 1, wherein the interface system is substantially free of wires.

4. The system of claim 1, wherein the system connector is flexible.

5. The system of claim 1, wherein the system connector comprises a polymer.

6. The discreet interface system of claim 5, wherein the polymer is an intrinsically conductive polymer.

7. The discreet interface system of claim 5, wherein the polymer is a non-conductive polymer.

8. The discreet interface system of claim 7, wherein the polymer is a silicone based polymer, polyurethane, thermoplastic elastomer, ethylene vinyl acetate copolymer, polyolefin elastomer, EPDM rubber or a combinations thereof.

9. The system of claim 1, wherein the system connector further comprises a conductive coating.

10. The system of claim 1, wherein the conductive fabric comprises metallic organza or metallic mesh.

11. The system of claim 1, wherein the conductive fabric comprises a metallic material.

12. The system of claim 11, wherein the metallic material comprises copper, silver, zinc, nickel, brass, gold, aluminum or a combination thereof.

13. The system of claim 1, wherein the system connector further comprises a loop-and-hook fastener.

14. The system of claim 1, wherein the garment trim comprises at least one snap, button, zipper, stud, ribbon, rivet, clasp, spike, or a combination thereof.

15. The system of claim 1, wherein the system further comprises at least one switch, wherein the at least one switch is incorporated into the garment.

16. The system of claim 1, wherein the system connector can be removably attached to a device connector.

17. A washable garment comprising:
an electronic interface comprising:
at least one garment trim;
conductive fabric, conductive thread or conductive polymer in electronic communication with the garment trim, wherein the conductive fabric, conductive thread or conductive polymer is capable of being integrated in the garment; and
a washable system connector in electronic communication with the conductive fabric, conductive thread or conductive polymer, wherein the washable system connector comprises a polymer.

18. The washable garment of claim 17, wherein the electronic interface further comprises at least one switch, wherein the switch is incorporated into the garment.

19. The washable garment of claim 17, wherein the electronic interface is discreet.

20. The washable garment of claim 17, wherein the garment is substantially free of wires.

21. The washable garment of claim 17, wherein the garment trim comprises at least one snap, button, zipper, stud, ribbon, clasp, rivet, spike, or a combination thereof.

22. The washable garment of claim 17, wherein the conductive fabric comprises a metallic organza or metallic mesh.

23. The washable garment of claim 17, wherein the conductive fabric or conductive thread comprises a metallic material.

24. The washable garment of claim 23, wherein the metallic material comprises copper, copper, silver, zinc, nickel, brass, gold, aluminum, or a combination thereof.

25. The system connector of claim 17, wherein the polymer is an intrinsically conductive polymer.

26. The system connector of claim 17, wherein the polymer is a non-conductive polymer.

27. The system connector of claim 26, wherein the polymer is a silicone based polymer, polyurethane, thermoplastic elastomer, ethylene vinyl acetate copolymer, polyolefin elastomer, EPDM rubber or a combinations thereof.

28. The washable garment of claim 17, wherein the system connector further comprises a loop-and-hook fastener.

29. The washable garment of claim 17, wherein the system connector further comprises a conductive coating.

30. The washable garment of claim 17, wherein the garment is a jacket.
